(19) United States
(12) Patent Application Publication
(10) Pub. No.: US 2006/0064563 A1
(43) Pub. Date: Mar. 23, 2006

(54) Caching presence detection data

(76) Inventor: Louis B. Hobson, Tomball, TX (US)

Correspondence Address: HEWLETT-PACKARD COMPANY;Intellectual Property Administration, P.O. Box 272400, Fort Collins, CO, 80527-2400, US

(21) Appl. No.: 10/947,451

(22) Filed: Sep. 23, 2004

(51) Int. Cl. G06F 12/00

(52) U.S. Cl. 711/170; 711/115

(57) ABSTRACT

In accordance with one embodiment of the present invention, a method for providing presence detection (PD) data of at least one memory module installed in a computer, comprising: retrieving PD data stored in the at least one memory module; and storing the retrieved PD data in a first non-volatile memory, wherein the at least one memory module and the first non-volatile memory are constructed and arranged such that the PD data stored in the first non-volatile memory can be more quickly accessed than the PD data stored in the at least one memory module.

### BACKGROUND

The processing capability of computer systems has continually increased in recent decades. With such advances there has been a concomitant increase in the demand for memory capacity. Consequently, there has been a trend toward providing system memory in module form, with each memory module typically comprising a small circuit card with a number of memory chips. Such memory modules may be plugged into a memory socket connected to a computer motherboard or memory carrier card to increase the memory capacity of a computer system. Examples of memory modules include SIMMs (Single In-line Memory Modules) and DIMMs (Dual In-line Memory Modules), among others.

Memory modules are commonly designed to operate in one of a variety of operational modes such as fast page mode (FPM), extended data out (EDO), synchronous DRAM (SDRAM), double data rate SDRAM (DDR SDRAM), parity and non-parity, error correcting (ECC) and non error-correcting, etc. Memory devices are also designed with a variety of performance characteristics such as access speed, refresh time and so on. To distinguish between the wide variety of memory modules that may be installed in a computer, individual memory modules typically include information identifying the architecture, operational modes and performance characteristics of the memory module. This information, commonly referred to as presence detection (PD) data, is utilized to configure a memory controller of the computer system to enable the memory controller to interoperate with the particular memory modules installed in the computer.

Generally, PD data is stored in an EEPROM or other non-volatile memory on each memory module, and is accessed, for example, when the computer system is initially powered and reset, when transitioning between certain power states, and during other events in which the memory controller is configured (“memory configuration events” herein). The PD data is accessed across a standard serial System Management Bus (SMBus), typically an industry-standard I²C™ bus. The PD data is reviewed to determine whether the memory module is compatible with system requirements. If the memory module is incompatible with system requirements, an error message may be issued or other action taken. Otherwise, the memory controller is configured and current operation, such as the boot sequence, power state transition, etc., is completed.

### SUMMARY

In accordance with one embodiment of the present invention, a method for providing presence detection (PD) data of at least one memory module installed in a computer is descirbed, comprising: retrieving PD data stored in the at least one memory module; and storing the retrieved PD data in a first non-volatile memory, wherein the at least one memory module and the first non-volatile memory are constructed and arranged such that the PD data stored in the first non-volatile memory can be more quickly accessed than the PD data stored in the at least one memory module.

In accordance with another embodiment of the present invention, a method for configuring a memory controller of a computer to interoperate with at least one installed memory module having presence detection (PD) data is described, comprising: comprising: retrieving a copy of the memory module PD data from a rapidly accessible non-volatile memory; and configuring the memory controller utilizing the PD data retrieved from the rapidly-accessible non-volatile memory.

In accordance with a further embodiment of the present invention, a computer having a processor and at least one installed memory module having presence detection (PD) is descibed, comprising: a non-volatile memory rapidly accessible by a processor of the computer; POST code operable to copy PD data stored in the at least one memory module to the non-volatile memory; and memory reference code operable to configure a memory controller of the computer utilizing the PD data stored in the rapidly-accessible non-volatile memory.

### BRIEF DESCRIPTION OF THE DRAWINGS

FIG. 1 is a schematic block diagram of an exemplary computer system in which embodiments of the present invention may be implemented.

FIG. 2 is a logical block diagram of the contents of a memory module shown in FIG. 1, in accordance with one embodiment of the present invention.

FIG. 3A is a logical block diagram of the contents of a system ROM such as the one illustrated in FIG. 1, in accordance with one embodiment of the present invention.

FIG. 3B is a logical block diagram of the contents of a presence detect (PD) data storage region which, in one embodiment, is stored in the system ROM shown in FIG. 3A.

FIG. 4 is a logical block diagram of presence detection (PD) cache management data in accordance with one embodiment of the present invention.

FIG. 5 is an interface block diagram showing the transfer of data in accordance with one embodiment of the present invention.

FIG. 6A is a high-level flow chart of the relevant operations performed by the POST code shown in FIG. 3A when executing, for example, on the processor shown in FIG. 1, in accordance with one embodiment of the present invention.

FIG. 6B is a flow chart of the relevant operations performed by the POST code shown in FIG. 3A when executing, for example, on the processor shown in FIG. 1, in accordance with one embodiment of the present invention.

FIG. 7A is a high-level flow chart of the relevant operations performed by the memory reference code shown in FIG. 3A when executing, for example, on the processor shown in FIG. 1, in accordance with one embodiment of the present invention.

FIG. 7B is a flow chart of the relevant operations performed by the memory reference code shown in FIG. 3A when executing, for example, on the processor shown in FIG. 1, in accordance with one embodiment of the present invention.

FIG. 8 is a flow chart of the relevant operations performed by a power management process when executing, for example, on the processor shown in FIG. 1, in accordance with one embodiment of the present invention.

### DETAILED DESCRIPTION

Certain embodiments of the present invention are directed to storing a copy of presence detection (PD) data of at least one installed memory module in a non-volatile memory that is rapidly accessible by a processor of a computer system. Such rapidly-accessible non-volatile memory may be a component of the processor chipset or may be a separate component accessible over a high speed bus, such as a system ROM accessible over the BIOS boot bus.

The PD data is required, for example, to configure the memory controller of the computer system during a boot-sequence, system reset, and some power-state transitions. Rather that retrieving the PD data from the memory modules over the relatively slow System Management bus (SMBus) during each of these and other memory configuration events, embodiments of the present invention quickly obtain the PD data from the rapidly-accessible non-volatile memory.

Specifically, the first time a computer system performs Power-On-Self-Test (POST) operations, embodiments of the present invention retrieve the PD data over the SMBus, caching the PD data to the rapidly-accessible non-volatile memory. Thereafter, the PD data is read and cached only when necessary, such as when the configuration of the installed memory modules changes. For example, the PD data is read and cached when memory modules are added, removed or replaced, or when the operational modes or performance characteristics of existing memory modules are changed, etc. Because these are rare occurrences, the PD data stored in the memory modules seldom changes and the PD data initially stored in the rapidly-accessible non-volatile memory remains valid. Such embodiments of the present invention, therefore, avoid the time lost through repetitious reading of essentially static PD data over a relatively slow SMBUS.

Also, utilizing a rapidly-accessible non-volatile memory to store PD data, and updating the PD data only when necessary, significantly reduces the time taken to retrieve the PD data to, for example, configure the memory controller. This, in turn, accelerates the speed at which processes which require memory configuration are performed. For example, some embodiments of the present invention enable computer systems to more rapidly perform certain power state transitions. This is particularly advantageous due to the advent of industry standards such as the Advanced Configuration and Power Interface (ACPI) standard which requires computer systems to provide almost instant user access regardless of the power state of the computer.

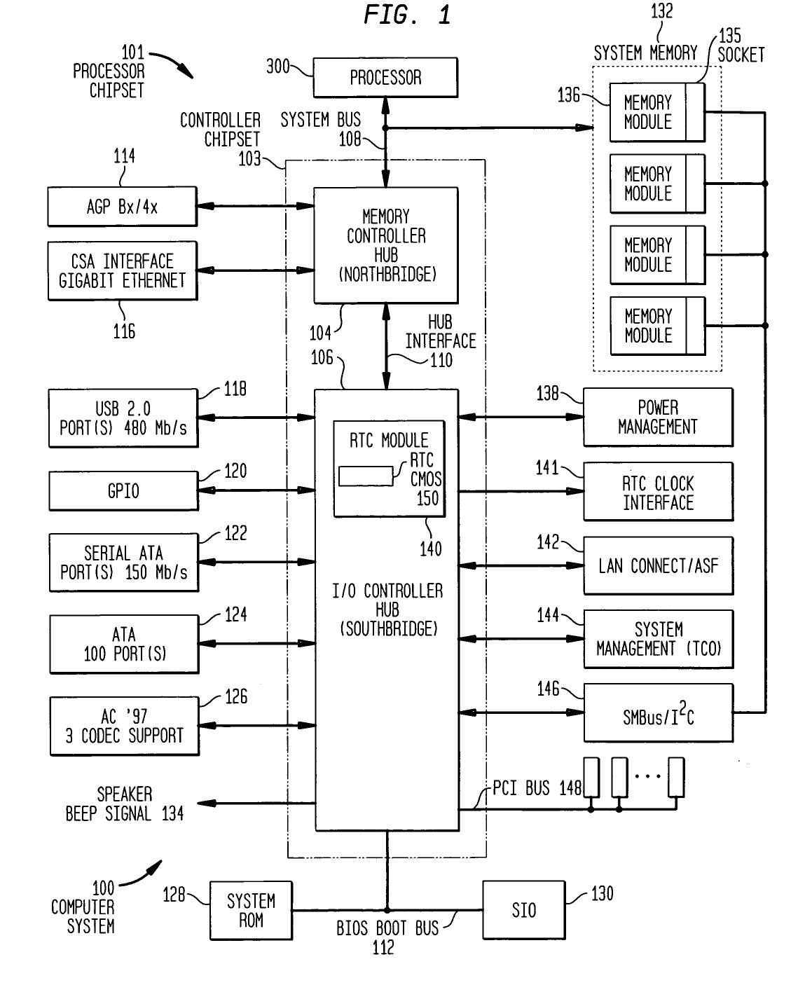

FIG. 1 is a block diagram of an exemplary computer system 100 suitable for implementing embodiments of the present invention. In this exemplary application, computer system 100 is a personal computer. It should be appreciated by those of ordinary skill in the art, however, that some embodiments of the present invention can be implemented in, for example, a workstation, laptop, server or any other computer system now or later developed that utilizes memory modules having presence detection (PD) data. As used herein, the terms “presence detection data” and “PD data” interchangeably refer to any information which may be used to identify any relevant characteristic of a memory module including but not limited to the noted architecture, performance characteristics and operational modes of the memory module.

Exemplary computer system 100 comprises a processor 102 connected directly to a controller chipset 103 that manages the flow of data in computer 100. Controller chipset 103 comprises a memory controller hub 104, commonly referred to as a Northbridge, which is connected to processor 102 via a system bus 108. Memory controller hub 104 is connected to a input/output (I/O) controller hub 106, commonly referred to as a Southbridge, via a hub interface bus 110. In one embodiment, processor 102 may be a microprocessor such a Pentium IV or other suitable microprocessor. Controller chipset 103 may be, for example, an 875P chipset, commercially available from Intel, Inc. Collectively, processor 102 and controller chipset 103 are commonly referred to as processor chipset 101. Such a processor chipset may include one or more integrated circuits depending on the implemented architecture.

Memory controller hub 104 manages the flow of information between various interfaces, commonly referred to as host bridge interfaces. Specifically, memory controller hub 104 manages system bus interface 108 with processor 102, and hub interface 110 with I/O controller 106. Memory controller hub 104 also supports an external AGP graphics device (not shown) via an AGP interface 114, and provides a Communications Streaming Architecture (CSA) Interface 116 to a Gigabit Ethernet (GbE) controller (also not shown). Memory controller hub 104 arbitrates between these interfaces, providing data coherency and performing address translation as necessary. In addition, memory controller hub 104 supports system memory 132, as described in greater detail below.

I/O Controller Hub 106 provides the data buffering and interface arbitration required to ensure that a variety of system interfaces operate efficiently. I/O controller hub 106 integrates controllers to support ATA 100 ports 124, Serial ATA ports 122, external Universal Serial Bus (USB) ports 118, general purpose input/output (GPIO) 120, audio CODer/DECoder (codec) 126, power management 138, LAN connection 142, system management 144 and PCI BUS 148.

I/O Controller Hub 106 also controls system management bus (SMBus) 146 which is typically an industry standard I²C™ serial bus. SMBUS 146 operates at a data transfer rate of up to 100 kilobits per second. As shown in FIG. 1, system memory 132 comprises a number of sockets 135 in which a memory module 136 can be installed. SMBus 146 is connected to each socket 135 in system memory 132. As will be described in detail below, presence detection (PD) data stored in a non-volatile portion of memory modules 136 is retrieved via SMBus 146 while data stored in a volatile region of memory modules 136 is directly accessed by memory controller hub 104 via system bus 108.

I/O Controller Hub 106 also controls a BIOS boot bus 112 to which system BIOS ROM 128 and super I/O (SIO) 130 are connected. In the embodiment shown in FIG. 1, BIOS boot bus 112 is a low pin count (LPC) bus, although other high-speed buses now or later may be utilized depending on the implemented architecture. BIOS boot bus 112 supports a high data transfer rate due to the need to transfer program code over the bus. For example, LPC data buses typically support a data transfer rate of approximately 16 megabytes per second.

As shown in FIG. 1, I/O Controller Hub 106 has a real-time clock (RTC) module 140 that provides an associated interface 141. RTC module 140 provides a date and time keeping device with static memory 150 and a battery back-up power source to maintain the contents of memory 150 during all power states of computer system 100. This on-chip data storage is typically implemented in CMOS (Complementary Metal Oxide Semiconductor) and is therefore commonly referred to as RTC CMOS, as depicted in FIG. 1. Certain embodiments of the present invention utilize RTC CMOS 150 as described below.

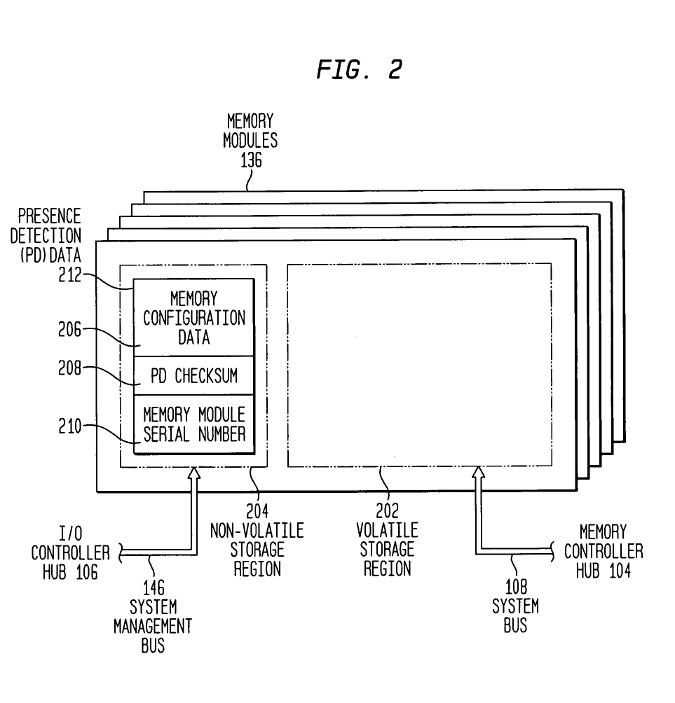

FIG. 2 is a simplified block diagram of memory modules 136 in accordance with one embodiment of the present invention. It should be understood that memory modules 136 can implement any memory architecture now or later developed capable of providing and supporting any desired operational mode and performance characteristic. For example, memory modules 136 may include dynamic random access memory (DRAM), Static Discharge RAM (SDRAM), Duel Data Rate RAM (DDR RAM), RAMBUS, single in-line memory modules (SIMMS), dual in-line memory modules (DIMMS), etc.

Each memory module 136 comprises at least one volatile storage region 202 in which data is stored by processor 102 under the control of memory controller 104. Each memory module 136 also comprises at least one non-volatile storage region 204, such as an EEPROM, in which presence detection (PD) data 212 is stored. As noted, presence detection data 212 may include a variety of information pertaining to the type, structure, configuration, capabilities, functionality, etc., of its memory module 136. Typically, PD data 212 includes 256 bytes of information comprising memory configuration data 206, PD checksum 208 and memory module serial number 210.

In this exemplary implementation, memory configuration data 206 is allocated bytes 0-62 and includes information such as module functional and performance information, superset data and revision information. PD checksum 208 is allocated, in this exemplary implementation, byte 63, and is a checksum for memory configuration data 206; that is, bytes 0-62. Memory module serial number 210 is typically a portion of manufacturer-related information provided as part of PD data 212, which is allocated bytes 64-127 of PD data 212 is this implementation. The remaining bytes 128-255 are generally reserved for system use. To ensure PD data 212 is not corrupted or overwritten at some later time, the data contained in bytes 0-127 is generally locked by the manufacturer once each memory module 136 is manufactured. PD data 212 can be read in serial or parallel format.

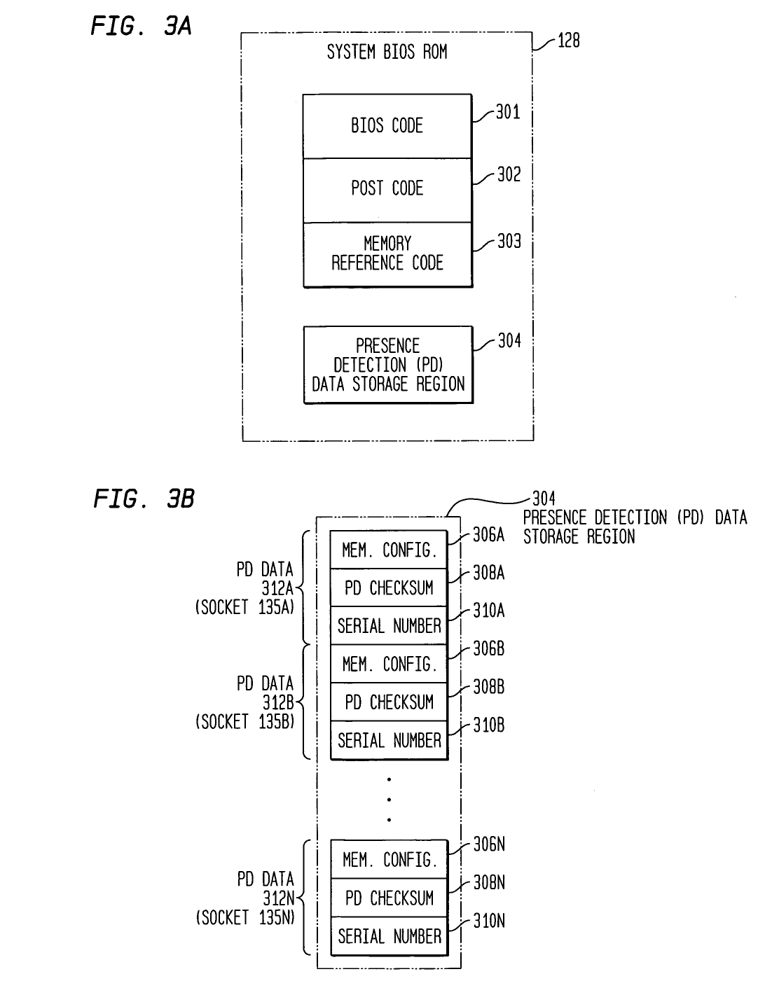

FIG. 3A is a logical block diagram illustrating the contents of system BIOS ROM 128 in accordance with one embodiment of the present invention. As is customary, system ROM 128 is implemented in non-volatile memory such as an electrically-erasable read-only memory (EEPROM) chip. System ROM 128 is commonly referred to as a flash BIOS, which can be updated through software control. Generally, system ROM 128 is located in a socket on the motherboard (not shown) of computer 100, although not all embodiments of computer system 100 have such a configuration.

As shown in FIG. 3A, system ROM 128 is configured to store Basic Input/Output System (BIOS) code 301, POST code 302 and memory reference code 303. Relevant aspects of BIOS code 301, POST code 302 and memory reference code 303 are described in detail elsewhere herein. In addition to storing the above and, perhaps, other code, this embodiment of system ROM 128 also comprises a presence detection (PD) data storage region 304 in which PD data is stored for each memory module 136 in computer system 100.

A logical block diagram of one embodiment of PD data storage region 304 is illustrated in FIG. 3B. In this illustrative embodiment, PD data storage region 304 has stored therein PD data for each memory module 136 installed in a memory module socket 135 of computer 100. For ease of distinction, the version of PD data stored in system ROM 128 for each memory module 136A-136N is referred to herein as PD data 312A-312N, respectively, while the same PD data stored in memory modules 136 is referred to herein as PD data 212A-212N, respectively. In other words, PD data storage region 304 is configured such that the contents of PD data 312A-312N corresponding to a socket 135 is effectively the same as PD data 212A-212N stored in a memory module 136A-136N installed in that socket. For example, PD data 312A comprises memory configuration data 306A, PD checksum 308A and serial number 310A, which are copies of memory configuration data 206, PD checksum 208 and serial number 210, respectively, of a memory module 136A installed in memory module socket 135A.

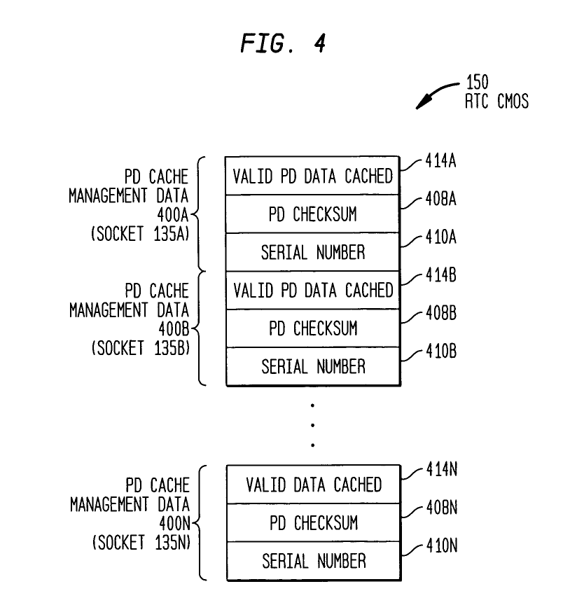

FIG. 4 is a logical block diagram of the contents of RTC CMOS 150, in accordance with one embodiment of the present invention. In certain embodiments, data is created and utilized to manage the storage of PD data 312 in system ROM 128. This data, collectively and generally referred to herein as PD cache management data 400A-400N, is separately maintained by POST code 302 for each memory module socket 135A-135N, respectively. As one of ordinary skill in the art would appreciate, during POST operations system memory 136 is not yet available for storage of data. Accordingly, PD cache management data 400 is stored in some other memory available to processor 102 prior to computer 100 becoming fully operational. In one embodiment, PD cache management data 400 is stored in RTC CMOS 150, which, as noted, is non-volatile memory accessible to processor 102. In other embodiments, valid PD cache management data 400 may be stored in available registers in processor chipset 101, or in system ROM 128. It should be appreciated, however, because system ROM 128 is generally flashed rather than written to on a byte-by-byte basis, this embodiment would require the flashing of PD cache management data 400 to system ROM 128.

PD cache management data 400A-400N each comprises a copy of PD checksum 208 and memory module serial number 210 from the respective memory module 136A- 136N installed in corresponding socket 135A-135N. For ease of reference, such copies of PD checksum 208 and memory module serial number 210 are referred to as PD checksum 408 and memory module serial number 410, respectively. In addition, and as will be described in detail below, each PD cache management data 400A-400N also comprises a valid PD data cached flag 414A-414N, respectively, which is used to indicate whether the corresponding PD data 312 is stored in system ROM 128. Accordingly, PD cache management data 400A comprises PD data cached flag 414A, PD checksum 408A and memory module serial number 410A; PD cache management data 400B comprises PD data cached flag 414B, PD checksum 408B and memory module serial number 410B, and so on.

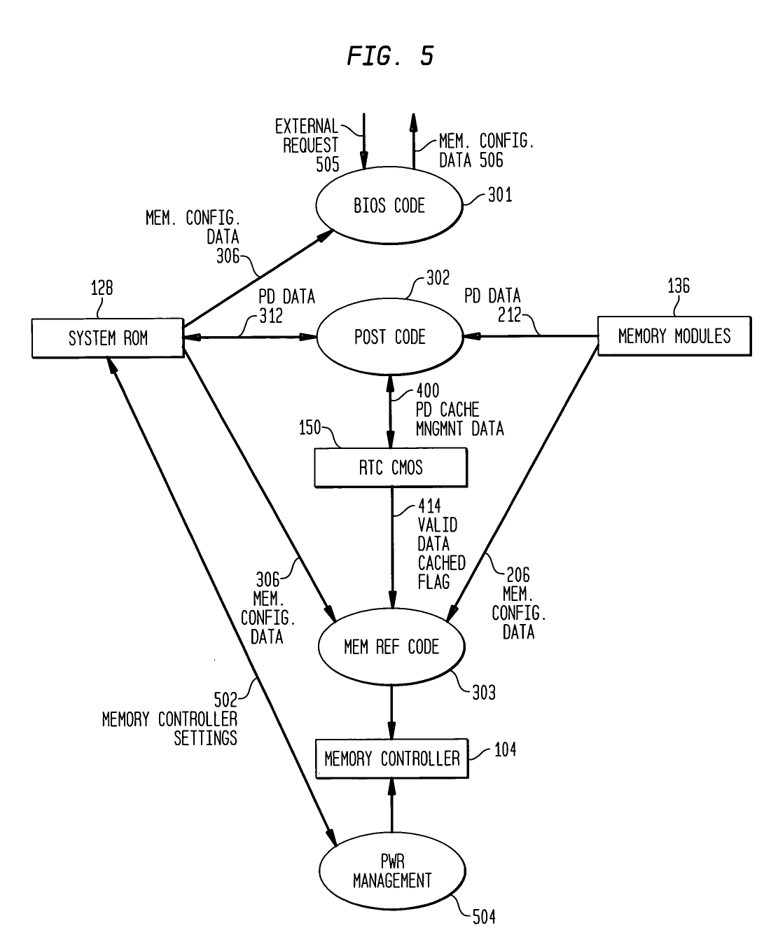

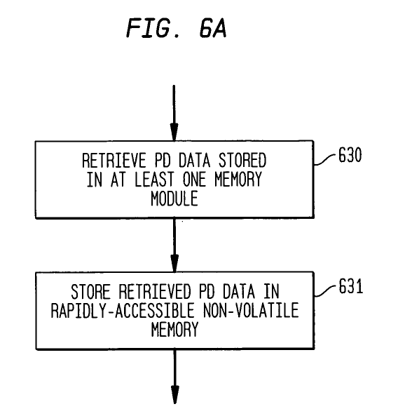

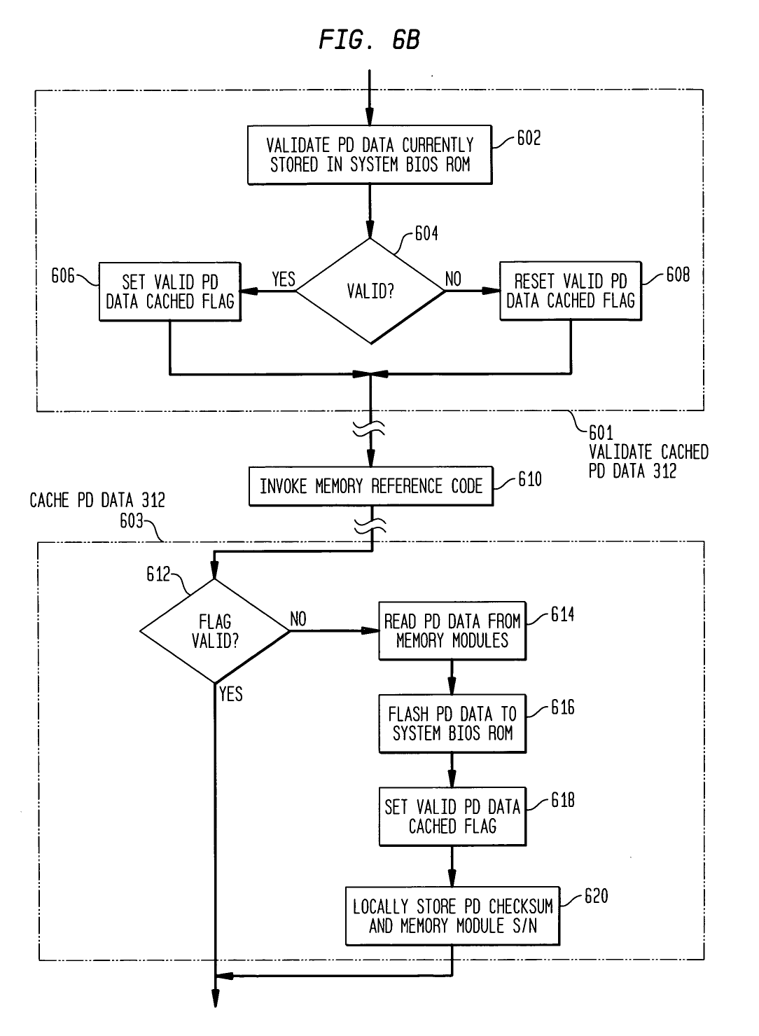

The operations performed by one embodiment of BIOS code 301, POST code 302 and memory reference code 303 are described next below with reference to FIGS. 1-4, introduced above, FIG. 5, which is an interface block diagram, and the flowcharts of FIGS. 6-8.

FIGS. 6A and 6B are flowcharts of the relevant operations performed by one embodiment of POST code 302 when executed by processor 102. One of the first operations performed by BIOS code 301 during a boot sequence is to execute POST code 302. POST code 302 verifies that all requisite hardware components are present and functioning properly to provide a boot environment for the operating system (not shown). In accordance with embodiments of the present invention, during POST, PD data 212 stored in memory modules 136 is read and cached to the rapidly-accessible non-volatile memory which, in one of the above-noted embodiments, is system ROM 128.

Referring to the high-level flowchart of FIG. 6A, at block 630, POST code 302 retrieves PD data 312 stored in memory modules 136. At block 631, POST code 302 stores the retrieved PD data 212 in rapidly accessible non-volatile memory 128.

Referring to the more detailed flowchart of FIG. 6B, there are three primary operations performed at blocks 601, 610 and 603. At block 601, POST code 302 validates PD data 312, if any, currently stored in system ROM 128. Memory reference code 303 is then invoked at block 610 to configure memory controller hub 104. As will be described in further detail below, memory reference code 303 utilizes PD data 312 stored in system ROM 128 when such PD data is determined to be valid; otherwise PD data 212 stored in memory modules 136 is utilized. At block 603, POST code 302 determines whether PD data 312 stored system ROM 128 is valid; that is, whether PD data 312 currently stored in system ROM 128 is the same as PD data 212 stored in currently-installed memory modules 136. If not, POST code 302 stores PD data 312 to system ROM 128 and updates PD cache management data 400 as necessary to indicate PD data 312 is valid.

Returning to block 601, the operations depicted at blocks 602-608 are performed in connection with the validation of PD data 312 currently stored in system ROM 128. At block 602, PD data 312 stored in data storage region 304 of system ROM 128 is examined to determine whether the PD data is valid. As noted, in one embodiment, RTC CMOS 150 is utilized to store valid data cached flag 414, PD checksum 408 and serial number 410 for each memory module socket 135A-135N in computer system 100. In one embodiment, the operations performed at block 602 involve reading PD checksum 308 for each memory module socket 135A-135N, and comparing that value to PD checksum 408 stored in RTC CMOS 150. In an alternative embodiment, at least a portion of serial number 310 for each memory module socket 135A-135N is compared to a corresponding portion of a serial number value 410A-410N stored in RTC CMOS 150. In a further embodiment, both values are read and compared. If it is determined that PD data 312 stored in system ROM 128 is valid (block 604), then a valid PD data cached flag 414 is set at block 606; otherwise the flag is reset at block 608.

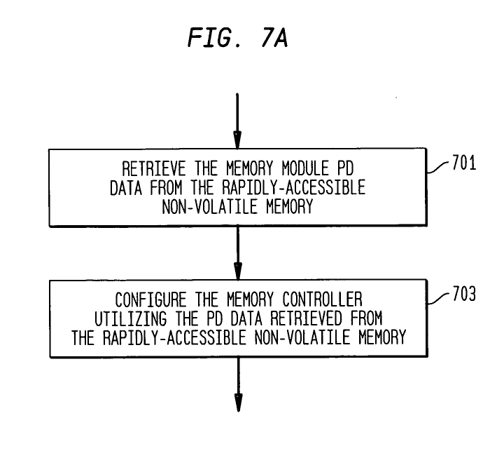

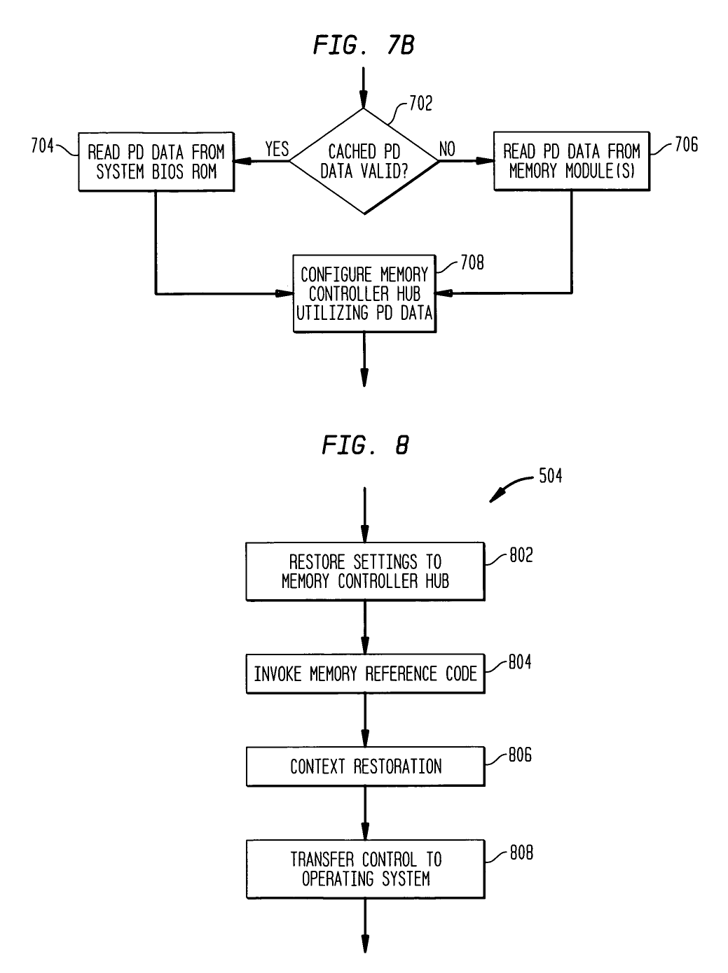

Once the validity of PD data 312 is determined, the execution of memory reference code 303 is invoked at block 610. One embodiment of the operations performed by memory reference code 303 is described in detail below with reference to FIG. 7.

When memory reference code 303 completes and control is returned to POST process 600, the operations depicted at blocks 612-620 are performed. At block 612, valid PD data cached flag 414 is read to determine whether PD data 312 is valid. The data may not be valid due to, for example, this being the first time computer system 100 is executing POST process 600. Alternatively, PD data 312 may be invalid due to the configuration of memory modules 136 being altered since the last execution of POST process 600. As noted, examples of such a configuration change include but are not limited to the addition, removal, replacement or modification of one or more memory modules 136.

Should flag 414 indicate that PD data 312 is invalid, then the operations depicted at blocks 614-620 are performed. At block 614, PD data 212 is retrieved from memory modules 136. In one embodiment, PD data 212 is retrieved from all memory modules 136. In an alternative embodiment, only PD data 212 stored in the memory module 136 for which the PD data 312 is determined to be invalid, is retrieved. At block 616, the retrieved PD data 212 is flashed to system ROM 128.

PD management data 400 is then updated to reflect the recent storage of PD data 312 in system ROM 128. At block 618, the appropriate valid PD data cached flag(s) 414 is/are set. At block 620, the retrieved PD checksum 208 and serial number 210 are stored in RTC CMOS 150 as PD checksum 408 and serial number 410, respectively.

It should be appreciated that upon the completion of the relevant operations of POST code 302, valid PD data 312 is stored in system ROM 128. It should also be appreciated that during the next execution of POST code 302, flag 414 will indicate that PD data 312 is valid, as determined at blocks 604 and 612. Thus, after the initial execution of POST code 302, the only operation performed by POST code 302 in connection with PD data 312 stored in system ROM 128 is the validation operation at block 602, except when the configuration of the memory modules 136 has changed.

As one of ordinary skill in the art would appreciate, the operations depicted in FIG. 6 are just a portion of the operations performed when a computer system performs power-on-self-test operations as part of a boot sequence, as illustrated by the arrows leading to and from the first and last block illustrated in FIG. 6. It should also be understood that certain operations may be performed prior or subsequent to the invocation of memory reference code 303, as illustrated by the discontinuity depicted in the arrows connecting block 606 with the blocks above and below block 606.

During POST operations and, in this exemplary application, during certain power state changes described below, memory reference code 303, is executed. Memory reference code 303 comprises various algorithms for configuring memory controller hub 104 to properly interoperate with the implemented memory modules 136. As noted, each time the system is booted, reset or transitioned between certain power states, conventional memory reference code retrieves presence detect data from memory modules 136 via SMBus 146, and configures the memory controller accordingly. In contrast, embodiments of the present invention comprise a memory reference code 303 that accesses system ROM 128 for PD data 312 unless the PD data is invalid, in which case memory reference code 302 obtains PD data 212 from memory modules 126.

FIGS. 7A and 7B are flow charts of the relevant operations performed by memory reference code 303 in accordance with embodiments of the present invention. Referring to the high-level flow chart of FIG. 7A, at block 701, memory reference code 303 retrieves PD data 312 from system ROM 128. The retrieved presence detection data 312 is then utilized by memory reference code 303 to configure memory controller hub 104 at block 703.

Referring to the more detailed flow chart of FIG. 7B, at block 702, memory reference code 303 determines whether valid PD data 312 is stored in system ROM 128. In the exemplary embodiment described above, memory reference code 303 reads valid PD data cached flag 414. As noted, valid PD data cached flag 414 is set or reset at blocks 606, 608, respectively, by POST code 302. Accordingly, in this embodiment, at block 702, memory reference code 303 accesses the appropriate bit in RTC CMOS 150 to determine whether valid PD data 312 is stored in system ROM 128.

If valid PD data 312 is stored in system ROM 128, then memory reference code 303 retrieves PD data 312 from presence detect data storage region 304. Otherwise, PD data 212 is retrieved from memory modules 136. The retrieved presence detection data is then utilized by memory reference code 303 to configure memory controller hub 104 at block 708.

It should be appreciated that when PD data 312 is utilized, memory reference controller 303 obtains that information by accessing system ROM 128 over BIOS boot bus 112. In contrast, when PD data 212 is utilized, memory reference controller 303 obtains the same PD data by accessing memory modules 126 over SMBus 146. As one of ordinary skill in the art would appreciate, the rate at which SMBus 146 transfers data is considerably slower than the rate at which the same data can be transferred over BIOS boot bus 112. Accordingly, memory reference code 303 can configure memory controller hub 104 substantially faster when the requisite PD data is located in system ROM 128. This has particular benefits when there is minimal time to transition computer system 100 to a fully operational state. Once such example noted above is when computer system 100 transitions from a low power state to a fully-powered state.

As one of ordinary skill in the art would appreciate, the operations depicted in FIG. 8 are just a portion of the operations performed by memory reference code 303, as illustrated by the arrows leading to and from the first and last block illustrated in FIGS. 7A and 7B.

FIG. 8 is a flow chart of certain operations performed when computer system 100 transitions from a low power state to a fully-powered state. In FIG. 5, such operations are performed by power management process 504. It is generally desired that such power state transitions occur as rapidly as possible. For example, the noted ACPI specification currently requires that a computer system transition from certain low-power state to a fully operational state in less than 500 ms.

In one low-power state, the power to most components of computer system 100 is removed, with the exception of the real-time clock and devices that have wake capability, which are provided with minimal power to enable them to detect a wake event. System memory 132 is in self-refresh which enables it to retain data stored in volatile memory storage region 202 of memory modules 136.

Conventional approaches to transitioning to a fully-powered state require the retrieval of presence data 212 from memory modules 136. In contrast, because of the storage of PD data 312 in system ROM 128 (or other rapidly-accessible non-volatile memory), memory reference code 303 is configured to obtain such information from system ROM 128 rather than memory modules 136, as described above. As noted, accessing memory modules 136 for PD data 212 requires the use of SMBus 146. In contrast, retrieving SPD data 312 from system ROM 128, which is located on BIOS boot bus 112, is considerably faster.

When transitioning to a fully powered state, process 504 performs the minimal number of operations necessary to return control to the operating system (not shown) which is responsible for performing the majority of the context restoration operations necessary to return computer system 100 to a fully operational state. At block 802, the setting in memory controller hub 104 are restored. In one embodiment, such settings are stored in system ROM 128 when computer system 100 transitions to a low-power state, although the setting may be stored in other non-volatile memory such as RTC CMOS 150. Referring to FIG. 5, this is illustrated as memory controller settings 502 being transferred between system ROM 128 and power management process 504.

At block 804, memory reference code 303 is executed. Referring to FIG. 7, at block 702 PD data 312 stored in system ROM 128 is always determined to be valid; that is, the valid PD data cached flag is set. There is no need to verify that this data is valid, such as by validating the PD checksum 208 or serial number 210, because valid PD data is always stored in system ROM when computer system 100 enters a sleep state. This is because, computer system 100 transitions to the low power state from a normal operating state, which occurs after the computer boot sequence is completed and POST operations have been performed. And, as one of ordinary skill in the art would appreciate, memory modules 136 cannot be reconfigured while computer system 100 is in a sleep state. Thus, PD data 312 stored in system ROM 128 is valid upon entering and exiting a sleep state. Thus, when memory reference code 303 is invoked from the power management process 504, memory reference code 303 performs the operations at blocks 704 and 708; that is, it reads PD data 312 from system BIOS ROM 128 and configures memory controller hub 104 at block 708.

At block 806, other operations associated with the restoration of context are performed. Such operations are not relevant to the present invention and, therefore, are not described further herein. Such context restoration operations are particular to the computer architecture and power management states implemented in computer system 100.

At block 808, control is passed to the operating system.

It should be appreciated that PD data 312 stored in system ROM 128 may be accessed for purposed other than to configure memory controller hub 104. For example, referring to FIG. 5, during normal operations of a computer system, BIOS code 301 receives from executing management processes requests 505 for memory configuration data 306. Conventionally, the BIOS would access memory modules 136 for the requested data. In contrast, in embodiments, BIOS code 301 retrieves memory configuration data 306 from system ROM 128, as shown in FIG. 5. BIOS code 301 provides such memory configuration data to the requesting process as memory configuration data 506. As a result, BIOS code 301 services such requests significantly faster than conventional approaches. In certain applications, a pointer to the requested memory configuration data rather than the data itself is requested. In such applications, BIOS code 301 may provide a pointer to PD storage region 304 rather than memory configuration data 306.

The embodiments of the present invention described above are exemplary only. For example, as noted, embodiments of the present invention cache presence detect data in non-volatile memory that is rapidly accessible by memory reference code 303. In the embodiment described herein, such non-volatile memory is system ROM 128 communicably coupled to processor 102 via a BIOS boot bus 112 such as an LPC bus. In certain embodiments of computer system 100, RTC CMOS 150 is utilized to store presence detect data. As noted, RTC CMOS 150 is available for RTC clock generation module 140 of I/O controller hub 106 to store time-related information. As is well-known in the art, when a chipset implements a Real Time Clock, applicable standards require at least a minimal amount of battery-powered non-volatile storage be provided on the chip. Some chipset vendors provide more memory than required to implement the RTC, which is then available for other purposes. In certain implementations, RTC CMOS 150 is sufficiently large to also store presence detect data for the quantity of memory modules 136 which may be installed in computer system 100. As one of ordinary skill in the art would appreciate, other on-chip non-volatile storage available on processor chipset 101 may also be utilized in addition to or instead of system ROM 128 and/or RTC CMOS 150. As another example, rapidly-accessible non-volatile memory of the present invention is accessible to processor 102 in the exemplary application described above. It should be appreciated, however, that such non-volatile memory may be accessible to other controllers now or later developed. As such, when used in such a context, the term “processor” broadly refers to any hardware and/or any software that controls at least a portion of the computer system.

What is claimed is:

1. A method for providing presence detection (PD) data of at least one memory module installed in a computer, comprising:
retrieving PD data stored in the at least one memory module; and
storing the retrieved PD data in a first non-volatile memory, wherein the at least one memory module and the first non-volatile memory are constructed and arranged such that the PD data stored in the first non-volatile memory can be more quickly accessed than the PD data stored in the at least one memory module.

2. The method of claim 1, wherein storing the retrieved PD data in a first non-volatile memory comprises:
storing the retrieved PD data in a system ROM of the computer, wherein the system ROM is accessible via a BIOS boot bus.

3. The method of claim 1, wherein retrieving PD data stored in the at least one memory module and storing the retrieved PD data in a first non-volatile memory are performed in response to a change in a configuration of the at least one memory module.

4. The method of claim 3, wherein the configuration of the at least one memory module changes when a memory module is added, removed or replaced.

5. The method of claim 1, further comprising:
determining whether valid PD data for the at least one memory module is stored in the rapidly-accessible non-volatile memory.

6. The method of claim 5, wherein determining whether valid PD data for the at least one memory module is stored in the rapidly-accessible non-volatile memory comprises:
comparing at least one of either a PD checksum value and at least a portion of a memory module serial number value previously stored in a second non-volatile memory with a PD checksum value or at least a portion of a memory module serial number value, respectively, retrieved from the at least one memory module.

7. The method of claim 6, wherein determining whether valid PD data for the at least one memory module is stored in the rapidly-accessible non-volatile memory further comprises:
storing in the second non-volatile memory at least one of either the PD checksum value and the a memory module serial number value for the at least one memory module at a time when the copy of the retrieved PD data is stored in the first non-volatile memory.

8. The method of claim 7, wherein the second non-volatile memory comprises a real time clock (RTC) memory of a processor chipset.

9. The method of claim 1, wherein retrieving PD data stored in the at least one memory module and storing the retrieved PD data in a first non-volatile memory are performed by power-on-self-test (POST) code executing in the computer.

10. The method of claim 1, wherein the presence detection data of each at least one memory module identifies architecture, operational modes and performance characteristics of that memory module.

11. A method for configuring a memory controller of a computer to interoperate with at least one installed memory module having presence detection (PD) data in response to a memory configuration event, comprising:
retrieving a copy of the memory module PD data from a rapidly accessible non-volatile memory; and
configuring the memory controller utilizing the PD data retrieved from the rapidly-accessible non-volatile memory.

12. The method of claim 11, further comprising:
determining, prior to retrieving the memory module PD data from the rapidly accessible non-volatile memory, whether valid PD data for the at least one installed memory module is stored in the rapidly-accessible non-volatile memory.

13. The method of claim 12, further comprising:
configuring the memory controller utilizing the PD data stored in the at least one installed memory module when valid PD data is not stored in the rapidly-accessible non-volatile memory.

14. The method of claim 11, wherein configuring the memory controller comprises:
configuring the memory controller utilizing the PD data stored in the rapidly-accessible non-volatile memory in response to an occurrence of a memory configuration event.

15. The method of claim 14, wherein the memory configuration event comprises at least one of turning on the computer, resetting the computer, and transitioning between power states in the computer.

16. The method of claim 12, wherein determining whether valid PD data for the at least one memory module is stored in the rapidly-accessible non-volatile memory comprises:
comparing at least one of either a PD checksum value and a memory module serial number value previously stored in a second non-volatile memory with a PD checksum value or a memory module serial number value, respectively, retrieved from the at least one memory module.

17. The method of claim 16, wherein determining whether valid PD data for the at least one memory module is stored in the rapidly-accessible non-volatile memory further comprises:
storing in the second non-volatile memory at least one of either the PD checksum value and the a memory module serial number value for the at least one memory module at a time when the copy of the retrieved PD data is stored in the first non-volatile memory.

18. The method of claim 11, wherein retrieving a copy of the memory module PD data from a rapidly accessible non-volatile memory comprises:
retrieving a copy of the memory module PD data from a system ROM of the computer via a BIOS boot bus.

19. The method of claim 11, wherein the presence detection data of each at least one memory module identifies at least one of an architecture, operational mode and performance characteristic of that memory module.

20. A computer having a processor and at least one installed memory module having presence detection (PD), comprising:
a non-volatile memory rapidly accessible by a processor of the computer;
POST code operable to copy PD data stored in the at least one memory module to the non-volatile memory; and
memory reference code operable to configure a memory controller of the computer utilizing the PD data stored in the rapidly-accessible non-volatile memory.

21. The computer of claim 20, wherein the memory reference code is operable to configure the memory controller utilizing the PD data stored in the rapidly-accessible non-volatile memory when valid PD data is stored in the rapidly-accessible non-volatile memory, and operable to configure the memory controller utilizing the PD data stored in the at least one memory module when valid PD data is not stored in the rapidly-accessible non-volatile memory.

22. The computer of claim 20, wherein the POST code is further operable to determine whether valid PD data for the at least one memory module is stored in the rapidly-accessible non-volatile memory.

23. The computer of claim 20, wherein to determine whether valid PD data is stored in the rapidly-accessible non-volatile memory, the POST code is further operable to compare for each of the at least one memory module, at least one of either a PD checksum value and a memory module serial number value previously stored in a second non-volatile memory of the computer, with a PD checksum value and memory module serial number value, respectively, retrieved from the at least one memory module.

24. The computer of claim 20, wherein the POST code is further operable to copy PD data stored in the at least one memory module to the non-volatile memory when the computer is initially powered and when a configuration of the at least one memory module has changed.

25. The computer of claim 20, wherein the rapidly accessible non-volatile memory comprises:
a system ROM of the computer accessible via a BIOS boot bus.

26. The computer of claim 20, further comprising:
a second non-volatile memory of the computer, wherein the POST code is operable to maintain in the second non-volatile memory data associated with the storage of PD data in the rapidly-accessible non-volatile memory.

27. The computer of claim 20, wherein the at least one memory module and the first non-volatile memory are constructed and arranged such that the PD data stored in the first non-volatile memory can be more quickly accessed than the PD data stored in the at least one memory module.

28. The computer of claim 20, wherein the presence detection data of each at least one memory module identifies architecture, operational modes and performance characteristics of that memory module.

29. The computer of claim 20, wherein the memory reference code is further operable to determine, prior to configuring the memory controller, whether valid PD data is stored in the rapidly-accessible non-volatile memory.

30. The computer of claim 29, further comprising:
configuring the memory reference code utilizes the PD data stored in the at least one memory module when valid PD data is not stored in the rapidly-accessible non-volatile memory.

31. The computer of claim 20, wherein the memory reference code configures the memory controller utilizing the PD data stored in the rapidly-accessible non-volatile memory in response to an occurrence of a memory configuration event.

32. The computer of claim 31, wherein the memory configuration event comprises at least one of turning on the computer; resetting the computer, transitioning between power states in the computer.

33. A computer having a processor and at least one installed memory module having presence detection (PD), comprising:
non-volatile memory means for being rapidly accessible by a processor of the computer;
means for copying PD data stored in the at least one memory module to the non-volatile memory; and
means for configuring a memory controller of the computer utilizing the PD data stored in the rapidly-accessible non-volatile memory.

34. The computer of claim 33, wherein the means for configuring the memory controller utilizes the PD data stored in the rapidly-accessible non-volatile memory means when valid PD data is stored in the rapidly-accessible non-volatile memory means, and utilizes the PD data stored in the at least one memory module when valid PD data is not stored in the rapidly-accessible non-volatile memory means.

35. The computer of claim 33, further comprising:
means for determining whether valid PD data for the at least one memory module is stored in the rapidly-accessible non-volatile memory means.

36. The computer of claim 33, wherein means for determining whether valid PD data for the at least one memory module is stored in the rapidly-accessible non-volatile memory means comprises:
means for comparing for each of the at least one memory module, at least one of either a PD checksum value and a memory module serial number value previously stored in a second non-volatile memory of the computer, with a PD checksum value and memory module serial number value, respectively, retrieved from the at least one memory module.

37. The computer of claim 33, wherein the means for copying PD data stored in the at least one memory module to the non-volatile memory does so when the computer is initially powered and when a configuration of the at least one memory module has changed.

38. The computer of claim 33, wherein the at least one memory module and the first non-volatile memory are constructed and arranged such that the PD data stored in the first non-volatile memory can be more quickly accessed than the PD data stored in the at least one memory module.
